(19) United States
(12) Patent Application Publication
(10) Pub. No.: US 2019/0300150 A1
(43) Pub. Date: Oct. 3, 2019

(54) MOVABLE SAFETY GUARD SYSTEM FOR UNMANNED AERIAL VEHICLE PROPELLERS

(71) Applicant: Walmart Apollo, LLC, Bentonville, AR (US)

(72) Inventors: John J. O'BRIEN, Farmington, AR (US); Donald R. HIGH, Noel, MO (US); Brian MCHALE, Oldham (GB); Trey BISHOP, Bentonville, AR (US)

(73) Assignee: Walmart Apollo, LLC, Bentonville, AR (US)

(21) Appl. No.: 16/358,023

(22) Filed: Mar. 19, 2019

Related U.S. Application Data
(60) Provisional application No. 62/649,955, filed on Mar. 29, 2018.

(51) Int. Cl. B64C 11/00; B64C 29/00

(52) U.S. Cl. CPC B64C 11/001; B64C 2201/108; B64C 2201/162; B64C 29/0016

(57) ABSTRACT

An unmanned aerial vehicle (UAV) includes one or more engines; a flight control system configured to control the one or more engines; one or more propellers operatively linked to the one or more engines to be driven by the one or more engines, the one or more propellers being located within corresponding one or more air ducts, each air duct having an air inlet opening and air outlet opening to allow passage of flow of air therethrough; and one or more safety guards configured to close each air inlet opening or each outlet air opening, or both of the one or more air ducts to prevent or reduce potential damage to or from the propellers and to open to allow flow of air through each air duct during flight.

### CROSS-REFERENCE TO RELATED APPLICATIONS

The present patent application claims priority benefit to U.S. Provisional Patent Application No. 62/649,955 filed on Mar. 29, 2018, the entire content of which is incorporated herein by reference.

### BACKGROUND

### 1. Technical Field

The present disclosure relates generally to unmanned aerial vehicles and more specifically to a movable safety guard system for unmanned aerial vehicle propellers and unmanned aerial vehicle having the same.

### 2. Introduction

Unmanned Aerial Vehicles (UAVs), commonly known as drones, are becoming ubiquitous. UAVs are increasingly used in aerial imagery and photography, for surveillance, commercial application, real-estate applications, scientific applications, equipment inspections, agricultural applications, military applications, and recreational applications. UAVs are also contemplated as transport vehicles for delivering packages. An UAV is an aircraft that is piloted without a human pilot aboard the aircraft. The UAV can be operated using a remote control device by a human operator. The UAV can also be operated autonomously by an onboard programmed or programmable computer(s) programmed to execute a specific series of commands or instructions to control the UAV.

Some UAVs, for example quadcopters, use propellers for lift and flight. However, these propellers may be prone to damage as blades of the propellers can collide with objects. In addition, rotating propellers can be a potential hazard to people and property and may injure people and destroy property.

Some UAVs, such as UAVs described in WO 2016/193690, are provided with a rotor guard or safety sheet that is folded against a lateral side of the body of the UAV in an un-deployed configuration and at least partially unfolded away from the body in a deployed configuration. An actuator is provided to deploy the safety sheet laterally from the un-deployed configuration to the deployed configuration so as to protect the UAV from damage in case of accident.

However, in these UAVs, the propellers or the blades of the propellers are not protected or safeguarded against hazardous objects as the blades are not completely protected from above or from below. Furthermore, in these UAVs, people or animals may also be injured by rotating propellers or blades as the blades or propellers are not fully enclosed and are accessible from above and below the blades. Therefore, there is a need for a novel safety guard system for UAVs that cures the above and other problems of existing techniques and systems.

### SUMMARY

An aspect of the present disclosure is to provide an unmanned aerial vehicle (UAV) including one or more engines; a flight control system configured to control the one or more engines; one or more propellers operatively linked to the one or more engines to be driven by the one or more engines. The one or more propellers are located within corresponding one or more air ducts, each air duct having an air inlet opening and air outlet opening to allow passage of flow of air therethrough. The UAV further includes one or more safety guards configured to close each air inlet opening or each outlet air opening, or both of the one or more air ducts to prevent or reduce potential damage to or from the propellers and to open to allow flow of air through each air duct during flight.

Additional features and benefits of the disclosure will be set forth in the description which follows, and in part will be obvious from the description, or can be learned by practice of the herein disclosed principles. The features and benefits of the disclosure can be realized and obtained by means of the instruments and combinations particularly pointed out in the appended claims. These and other features of the disclosure will become more fully apparent from the following description and appended claims, or can be learned by the practice of the principles set forth herein. It is to be expressly understood, however, that the drawings are for the purpose of illustration and description only and are not intended as a definition of the limits of the disclosure.

### BRIEF DESCRIPTION OF THE DRAWINGS

FIG. 1 shows schematically an unmanned aerial vehicle (UAV), according to an embodiment of the present disclosure;

FIGS. 2A-2C depict a safety guard mounted to an air duct, according to an embodiment of the present disclosure;

FIG. 3 is a schematic representation of a safety guard system using a pulley and belt system to move the safety guard system, according to an embodiment of the present disclosure;

FIG. 4 is a schematic representation of a safety guard system having a plurality of covers, according to an embodiment of the present disclosure; and

FIG. 5 is a schematic representation of a flow of air generated by the rotation of a propeller within an air duct, according to an embodiment of the present disclosure.

### DETAILED DESCRIPTION

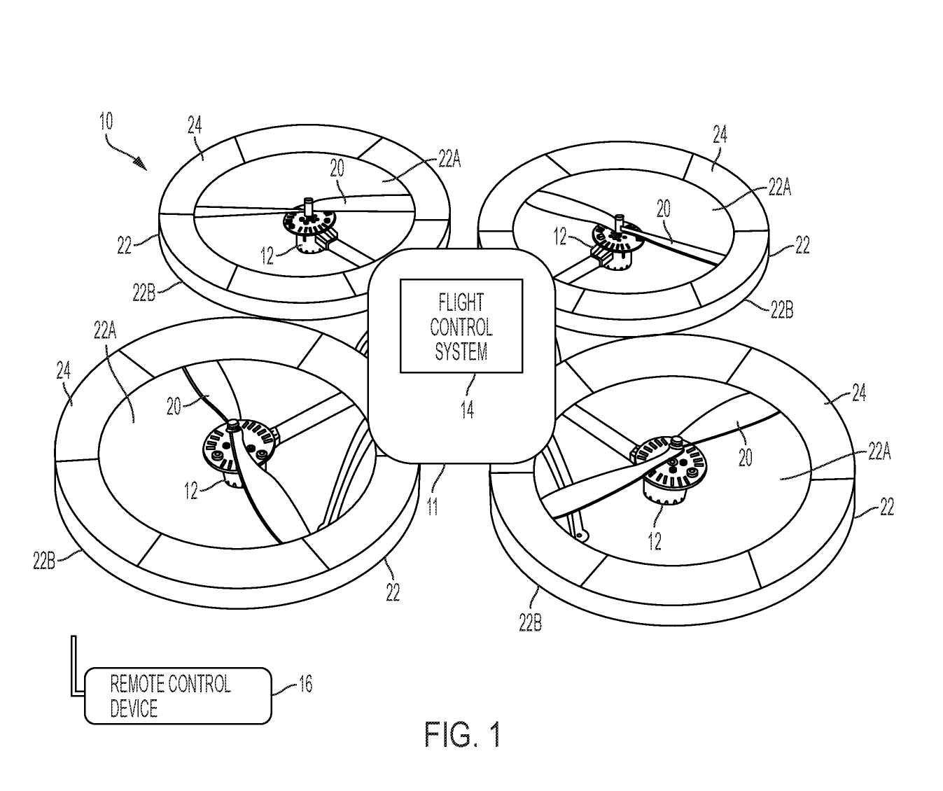

FIG. 1 shows schematically an unmanned aerial vehicle (UAV) 10, according to an embodiment of the present disclosure. The UAV 10 includes one or more engines 12. The one or more engines 12 are mounted to a body 11 of the UAV 10. The one or more engines 12 can be electrical engines that are powered by electrical batteries, such as for example, lithium-ion batteries that can be rechargeable using another electrical energy source or using solar panels. The one or more engines 12 can also be chemically-powered engines, etc.

The UAV 10 further includes a flight control system 14 configured to communicate with a control device 16 and configured to control the one or more engines 12. In an embodiment, the flight control system 14 can be mounted to the body 11 of the UAV 10 and can be configured to communicate with the control device 16 (e.g., a remote control device) wirelessly, for example, in the WIFI frequency band and/or in the BLUETOOTH frequency band, etc. In an embodiment, for example, a user can input commands to the control device 16 which in turn transmits a signal wirelessly to the flight control system 14 to control various functions of the UAV 10 including take off, flight and landing of the UAV 10. In another embodiment, the control device 16 may be provided onboard of the UAV 10. In which case, the control device 16 may send signals to the flight control system 14 through a wired connection. In this case, input from a user may not be needed as the control device 16 may receive inputs through sensors such altimeter sensors, distance sensors, etc. The control device 16 and/or the flight control system 14 can be programmed to execute a specific series of instructions depending on sensor(s) inputs to operate the UAV 10 autonomously. Although the control device 16 and flight control system 14 are described in this example as being separate devices, the functions of the flight control system 14 and the functions of the control device 16 can be integrated in a single device. In an embodiment, the UAV 10 may also be provided with a location module (not shown) configured to provide a position of the UAV 10. The location module, for example a Global Positioning System (GPS) unit, can be located within the flight control system 14. For example, the flight control system 14 can be configured to transmit the location of the UAV 10 to an operator of the UAV 10.

The UAV 10 also includes one or more propellers 20 operatively linked to the one or more engines 12 to be driven by the one or more engines 12. The one or more propellers 20 are located within corresponding one or more air ducts 22. In an embodiment, the one or more ducts 22 are mounted to the body 11 of the UAV 10. Each air duct 22 has an air inlet opening 22A and air outlet opening 22B to allow passage of flow of air therethrough. In an embodiment, as shown in FIG. 1, the one or more air ducts 22 have a cylindrical configuration in which the base of the cylinder is a circle. However, in other embodiments, the one or more air ducts 22 can have a cylindrical, conical or other tubular shape wherein the base of the shape can be a circle, an ellipse, or a polygon (e.g., pentagon, hexagon, etc.). In an embodiment, the air inlet opening 22A and the air outlet opening 22B of the one or more air ducts 22 can have the same or different shapes and/or dimensions.

The UAV 10 also includes one or more safety guards 24 configured to close each air inlet opening 22A or each air outlet opening 22B, or both, to protect the one or more propellers 20 therein from damage when the UAV 10 is at rest and to open to allow flow of air through each air duct 22 during flight. The one or more safety guards 24 may also be provided to protect people and animals from potential injury and protect property from damage. FIG. 1 shows one or more safety guards 24 that are provided to open or close each air inlet opening 22A. A similar one or more safety guards 24 (not shown in FIG. 1) can also be provided to open or close each air outlet opening 22B. The one or more safety guards 24 can also be controlled to open or close to any desired level to control a flow of air through the one or more air ducts 22 and thus control a thrust of the propellers 20. For example, as shown in FIG. 1, the safety guards 24 are partially closed/opened. This can be, for example, performed during a phase of decent prior to landing of the UAV 10 in preparation to a closing of the safety guards in case of emergency or when operating the UAV 10 in a vicinity of buildings or people.

For example, the one or more safety guards 24 can be configured to close when the UAV 10 is stored and configured to open when the UAV 10 is in flight. The opening and closing of the one or more safety guards 24 can be controlled by the flight control system 14. For example, if the UAV 10 experiences a critical failure while in flight, the flight control system 14 of the UAV 10 can command through a servo connected to one or more actuators of the one or more safety guards 24 to close the safety guards 24. This will contain the propellers 20 inside the safety guards 24 within the air ducts 22 thereby preventing or reducing potential damage to or from the propellers 20. In an embodiment, the one or more safety guards 24 can be made from a material resistant to shock or collision (e.g., a high impact strength polymer material or composite material). In addition, the one or more safety guards 24 may also include or be made of sound absorbing materials to reduce the noise emitted from the propellers 20.

In an embodiment, each of the engines 12, each of associated propellers 20, each of the associated air duct 22, and each of the associated one or more safety guards 24 can be provided as a propulsion assembly that can be removably mounted to the body 11 of the UAV 10. In an embodiment, the body 11 is configured to support the one or more engines 12, the flight control system 14, the one or more propellers 20, the one or more air ducts 22, and the one or more safety guards 24. Each propulsion assembly comprising engine 12, propellers 20, air duct 22 and one or more safety guards 24 can be electrically connected to the flight control system 14 provided on the body 11 of the UAV 10. In this way, the UAV 10 can be rendered modular in that one or more propulsion assemblies can be mounted to the body 11 of the UAV 10. For example, as depicted in FIG. 1, four propulsion assemblies comprising engine 12, propellers 20, air duct 22 and one or more safety guards 24 are mounted to the body 11 of the UAV 10. However, as it can be appreciated, the body 11 can be configured to receive any number of propulsion assemblies (e.g., one or more). As a result, the propulsion system of the UAV 10 can be rendered modular. In this way, two, three, four, or more propulsion assemblies can be mounted to the body 11 and connected to the flight control system 14 of the UAV 10 as desired depending to the needs of the user. For example, if the UAV 10 is used to transport packages, depending on the weight of the package(s), a specific number of propulsion assemblies can be used to provide desired lift and flight. For instance, for transporting relatively light packages, a smaller number of propulsion assemblies (e.g., four) may be used, while for transporting relatively heavy packages, a greater number of propulsion assemblies (e.g., six) may be used. Similarly, depending on distance to be traveled by the UAV 10, a user may select to use a certain number of propulsion assemblies. For example, for traveling or flying relatively smaller distances, a smaller number of propulsion assemblies (e.g., four) may be used, while for traveling or flying relatively greater distances, a larger number of propulsion assemblies (e.g., four) may be used. For example, by using only the number of propulsion assemblies as needed, the power of the battery or batteries that powers the propulsion assemblies can be extended.

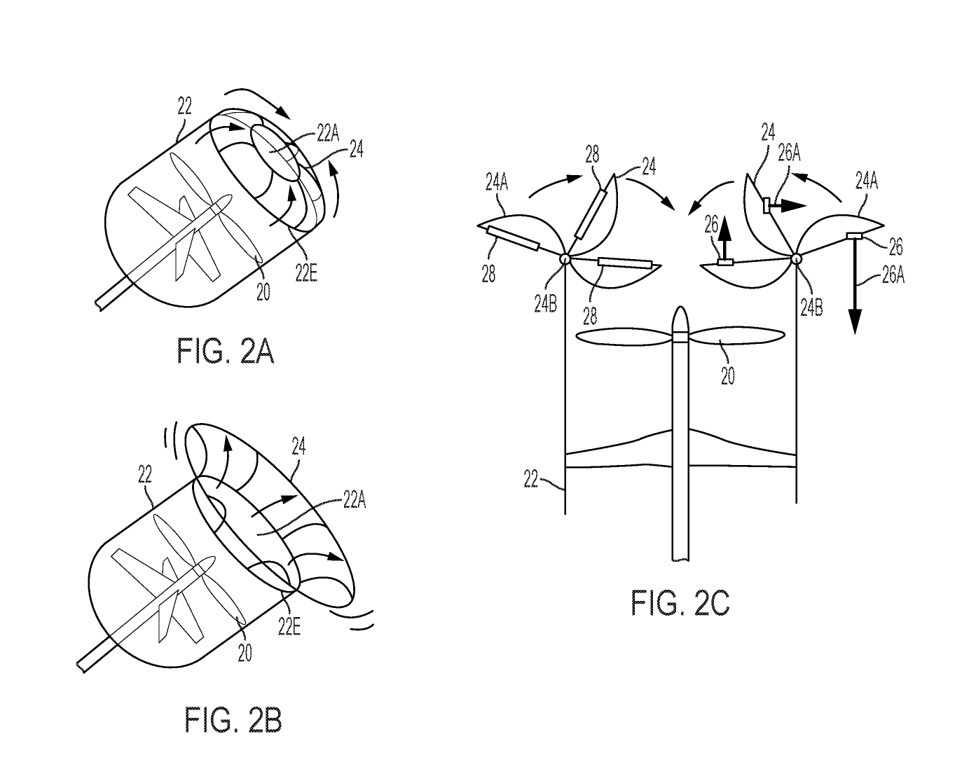

FIGS. 2A-2C depict a safety guard mounted to an air duct, according to an embodiment of the present disclosure. As shown in FIGS. 2A-2C, the safety guard 24 can be amounted to an edge 22E of the air duct 22. The safety guard 24 can be configured to rotate or pivot to open of close the air inlet opening 22A. FIG. 2A shows the safety guard 24 rotated inwardly towards the air inlet opening 22A in a closed configuration to substantially close the air inlet opening 22A, according to an embodiment of the present disclosure. FIG. 2B shows the safety guard 24 rotated outwardly away from the air inlet opening 22A in an open configuration to substantially open the air inlet opening 22A, according to an embodiment of the present disclosure. FIG. 2C is a lateral cross-section of the safety guard 24 and air duct 22 showing a progressive rotation of the safety guard 24, according to an embodiment of the present disclosure. For example, in an embodiment, the safety guard 24 can include a plurality of plates 24A which can be mounted to the edge 22E of the air duct 22 via a hinge 24B. The plates 24A can be rotated to converge toward each other to provide the safety guard 24 in a closed configuration that closes the air inlet opening 22A. Conversely, the plates 24A can also be rotated to diverge from each other to provide the safety guard 24 in an open configuration that opens the air inlet opening 22A. For example, the hinge 24B enables rotating the plates 24A of the safety guard 24 relative to a lateral wall of the air duct 22.

In an embodiment, the UAV 10 may also include a laser system 26. In an embodiment, the laser system 26 can be mounted to the safety guard 24 (e.g., mounted to the plates 24A of the safety guard 24) to enable orienting and changing a projection of one or more laser beams 26A from the laser system 26, as depicted in FIG. 2C. The laser system 26 can be used as collision avoidance system to detect object in the vicinity of the UAV 10 during flight. The laser system 26 may also be used as an altimeter system for determining the altitude of the UAV 10. The ability to orient the laser beams 26A by using the hinge 24B of the safety guard 24 enables collecting dynamic readings. Current laser altimeters that are used in UAVs are only used in a static manner with no ability to change the projection for the laser. In an embodiment, for example, the laser system 26 can be used as a laser altimeter to determine when UAV 10 lands on the ground. When the flight control system 14 receives altimeter data from the laser system 26 indicating that the UAV 10 is on the ground, the flight control system 14 can send a command to actuators of the safety guard 24 to close the safety guard 24. For example, as illustrated in FIG. 2C, when the safety guard 24 is in the open position and the plates 24A are relatively horizontal, the laser beam 26A emitted by the laser system 26 points towards the ground. As a result, in this configuration, the laser system 26 can provide measurements of the altitude of the UAV 10 relative to the ground. In another example, as also illustrated in FIG. 2C, when the plates 24A are relatively vertical, the laser beam 26A emitted by the laser system 26 is directed relatively horizontally. As a result, in this configuration, the laser system 26 can be used to measure a distance between the UAV 10 and other objects (e.g., buildings, trees, etc.) during flight. The measured distance can be used by the flight control system 14 of the UAV 10 for implementing object avoidance when needed.

In an embodiment, the safety guard 24 may also include solar cells or solar radiation harvesting elements 28 configured to convert solar radiation into electrical energy to recharge a battery used to drive the one or more engines 12. For example, the solar cells or solar radiation harvesting elements 28 can be provided on a surface of the plates 24A, as shown in FIG. 2C. For example, when the plates 24A are in the closed configuration, the solar cells or solar radiation harvesting elements 28 can be configured and arranged to be oriented towards the sun to maximize power generation when the UAV 10 is not in flight. Alternatively, the solar cells or solar radiation harvesting elements 28 can also be configured and arranged to be oriented towards the sun to maximize power generation when the plates 24A are in the open position when the UAV 10 is in flight to generate electrical power so as not to drain the battery quickly. This may enable increasing the period of flight of the UAV 10 by reducing the frequency of recharging the battery on the ground. Furthermore, because the safety guard plates 24A can rotate on hinge 24B, the UAV 10 can adjust the angle of orientation of the plates 24A of the safety guard 24 to be the most efficient in collecting solar energy.

In another embodiment, instead of using plates that are mounted via a hinge to an edge of the air duct 22, a system similar to a diaphragm of camera shutter can also be used. In this case, the plates of the diaphragm camera shutter can move relative to each other in one plane to open or close the air inlet opening 22A. The safety guard 24 can be actuated by one or more actuators (not shown in FIGS. 2A-2C) to close or open the air inlet opening 22A. For example, in an embodiment, the actuators can be controlled by the flight control system 14 or can be controlled by an independent control device.

In the above paragraphs, the safety guard 24 is described as being used to open or close the air inlet opening 22A. However, although not specifically shown in FIGS. 2A-2C, the safety guard 24 can also be used to open or close the air outlet opening 22B in a similar fashion as for the air inlet opening 22A.

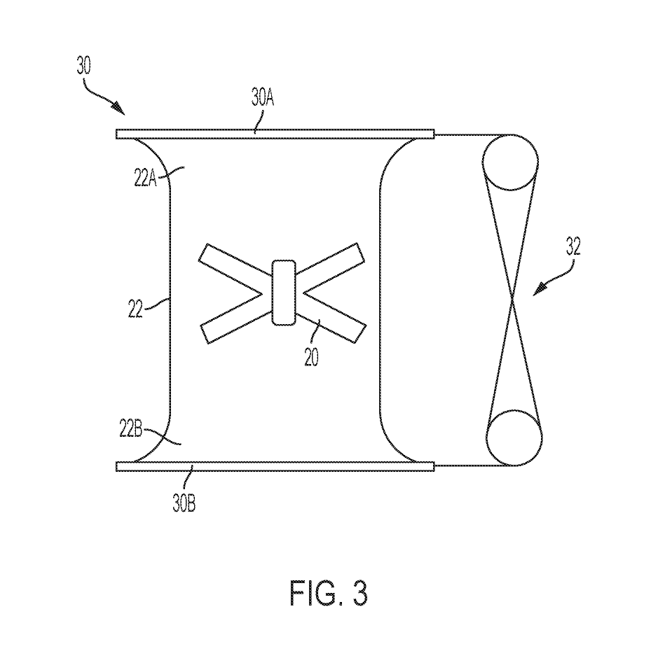

FIG. 3 depicts a schematic representation of a safety guard system using a pulley and belt system to move a safety guard system, according to an embodiment of the present disclosure. As shown in FIG. 3, a safety guard system 30 comprises an upper cover 30A and a lower cover 30B. The upper cover 30A is configured to move to open or close the air inlet opening 22A and the lower cover 30B is configured to move to open or close the air outlet opening 22B. The upper cover 30A and lower cover 30B are operatively linked to an actuating mechanism 32, such as a pulley and belt system. The actuating mechanism 32 is configured to move the upper cover 30A and the lower cover 30B to open or close the upper and lower covers 30A and 30B. In an embodiment, for example, a rotation of the propellers 20 can be used to open or close the upper and lower covers 30A and 30B. For example, the upper cover 30A and lower cover 30B can be opened and/or closed based upon air velocity. In an embodiment, electric actuators (e.g., motors) can also be employed to cause the upper and lower covers 30A and 30B to close or open. A resilient member (e.g., a spring) can be provided to cause the upper cover 30A and the lower cover 30B to move into place to guard the propellers 20 in the event of a loss of power. The electric actuators (e.g., motors) can be used to pull against the force of the resilient member once electric power is reestablished.

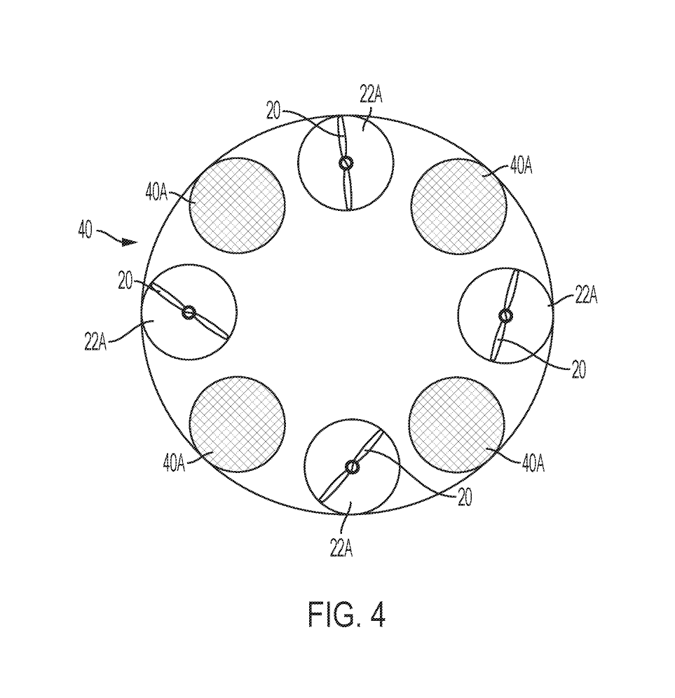

FIG. 4 depicts a schematic representation of a safety guard system having a plurality of covers, according to another embodiment of the present disclosure. As shown in FIG. 4, the safety guard system 40 has a plurality of covers 40A that are linked together. For example, the covers can be linked together so as to form a single body. For example, holes can be formed in a material (e.g., plastic) and the holes covered with a screen mesh or grill 40A. The screen mesh or grill can be configured to cover the air inlet opening 22A. In this way, the screen mesh covers 40A can rotate together as one unit to open or close the air inlet openings 22A. Resilient members, such as springs, can be used to hold the covers 40A in the closed position. Actuators can apply a force opposite to the spring force to move the safety guard system 40 including the plurality of covers 40A when the UAV 10 is in operation.

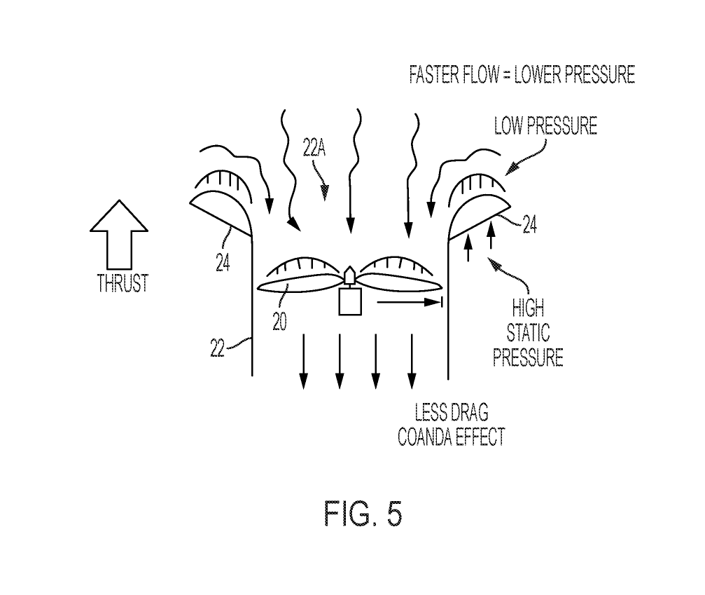

FIG. 5 is a schematic representation of a flow of air generated by the rotation of the propeller within the air duct, according to an embodiment of the present disclosure. As shown in FIG. 5, when the propeller 20 rotates at a relatively high velocity, the flow of air moves in the air duct 22, from above the propeller 20, from air inlet opening 22A, to below the propeller 20 to exit through the air outlet opening 22B of the air duct 22. A gradient of air pressure is created by the movement of air in the air duct 22 wherein lower air pressure is generated above the propeller 20 and higher pressure is generated below the propeller 20 to generate thrust to lift the UAV 10. By using air duct 22, drag can be reduced. In addition, the air duct 22 provides support for the safety guard 24. Furthermore, the rotation of the propeller 20 can also assist in the closing of the safety guard 24. As illustrated in FIG. 5, the rotation of the propeller creates a low pressure above the safety guard 24 and a higher pressure below the safety guard 24 thus generating a differential pressure. The differential pressure is translated into a force that is applied to the back of the safety guard 24 to bias the safety guard 24 towards a closing position to close the inlet opening 22A. As a result, in the event of a loss of power, the safety guard 24 will pivot automatically, due to the presence of the biasing force, to close the air inlet opening 22A to prevent potential damage to or from the propeller 20. Therefore, the safety guard 24 acts as a “fail-safe” device, in that in case of electrical failure, the safety guard 24 will rotate to enclose the propeller 20 within the air duct 22.

The term “flight control system” or “remote control device” is used herein to encompass any data processing system or processing unit or units. The remote control device may include, for example, a desktop computer, a laptop computer, a mobile computing device such as a PDA, a tablet, a smartphone, etc. A computer program product or products may be run on the flight control system and/or the remote control device to accomplish the functions or operations described in the above paragraphs. The computer program product includes a computer-readable medium or storage medium or media having instructions stored thereon used to program the flight control system and/or the remote control device to perform the functions or operations described above. Examples of suitable storage medium or media include any type of disk including floppy disks, optical disks, DVDs, CD ROMs, magnetic optical disks, RAMs, EPROMs, EEPROMs, magnetic or optical cards, hard disk, flash card (e.g., a USB flash drive, SD card, Multi-Media Card), PCMCIA memory card, smart card, or other media. Alternatively, a portion or the whole computer program product can be downloaded from a remote computer or server via a network such as the internet, an ATM network, a wide area network (WAN) or a local area network.

Stored on one or more of the computer-readable media, the program may include software for controlling both the hardware of a general purpose or specialized computer system or processor. The software also enables the processor to interact with a user via output devices such as a graphical user interface, head mounted display (HMD), etc. The software may also include, but is not limited to, device drivers, operating systems and user applications. Alternatively, instead or in addition to implementing the methods described above as computer program product(s) (e.g., as software products) embodied in a computer, the method described above can be implemented as hardware in which, for example, an application specific integrated circuit (ASIC) or graphics processing unit or units (GPU) can be designed to implement the method or methods, functions or operations of the present disclosure.

The various embodiments described above are provided by way of illustration only and should not be construed to limit the scope of the disclosure. Various modifications and changes may be made to the principles described herein without following the example embodiments and applications illustrated and described herein, and without departing from the spirit and scope of the disclosure.

Although the embodiments of disclosure have been described in detail for the purpose of illustration based on what is currently considered to be the most practical, it is to be understood that such detail is solely for that purpose and that the present disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

We claim:

1. An unmanned aerial vehicle (UAV) comprising:
a body;
one or more engines coupled to the body;
a flight control system disposed in the body and configured to control the one or more engines;
an air duct coupled to the body, the air duct including a wall defining an open interior portion, the wall having a top end and a bottom end and being open at the top end and the bottom end to define an air inlet and air outlet to allow passage of flow of air therethrough, via the interior portion;
a propeller disposed in the interior portion and operatively linked to the one or more engines to be driven by the one or more engines; and
a safety guard arranged at the top end of the wall or the bottom end of the wall and configured to close the air inlet opening or the outlet air opening, or both, the safety guard extending completely around the wall and is moveable between an open position and a closed position to extend over the top end or the bottom end to partially close the interior portion, the safety guard comprising a plurality of plates coupled to the wall that are configured to move relative to each other in one plane.

2. An unmanned aerial vehicle (UAV) comprising:
one or more engines;
a flight control system configured to control the one or more engines;
one or more propellers operatively linked to the one or more engines to be driven by the one or more engines, the one or more propellers being located within corresponding one or more air ducts, each air duct having an air inlet opening and air outlet opening to allow passage of flow of air therethrough; and
one or more safety guards configured to close each air inlet opening or each outlet air opening, or both of the one or more air ducts to prevent or reduce potential damage to or from the propellers and to open to allow flow of air through each air duct during flight.

3. The unmanned aerial vehicle according to claim 2, wherein the one or more safety guards are configured to protect the one or more propellers within the corresponding one or more air ducts from damage when the UAV is at rest.

4. The unmanned aerial vehicle according to claim 2, wherein the safety guards are actuated by one or more actuators to close or open each air inlet opening and each air outlet opening, wherein the actuators are controlled by the flight control system.

5. The unmanned aerial vehicle according to claim 2, wherein the one or more safety guards are mounted to the one or more air ducts via a hinge system to enable rotating the one or more safety guards relative to a lateral wall of the one or more air ducts.

6. The unmanned aerial vehicle according to claim 2, further comprising one or more laser systems that are mounted to the one or more safety guards, wherein the one or more safety guards are configured to rotate so as to orient and change a projection of one or more laser beams from the one or more laser systems.

7. The unmanned aerial vehicle according to claim 2, wherein the one or more safety guards comprise a grill configured to let the flow of air therethrough while preventing or reducing potential damage to or from the propellers.

8. The unmanned aerial vehicle according to claim 7, wherein the grill is configured to cover each air inlet opening or each air outlet opening, or both.

9. The unmanned aerial vehicle according to claim 2, wherein the one or more safety guards comprise plates having solar cells or solar radiation harvesting elements configured to transform solar radiation into electrical energy to recharge a battery used to drive the one or more engines.

10. The unmanned aerial vehicle according to claim 2, further comprising a location module configured to provide a position of the UAV.

11. The unmanned aerial vehicle according to claim 2, further comprising a remote control device configured to communicate with the flight control system to control the one or more engines.

12. The unmanned aerial vehicle according to claim 2, further comprising a body, wherein the body is configured to support the one or more engines, the flight control system, the one or more propellers, the one or more air ducts, and the one or more safety guards.

13. The unmanned aerial vehicle according to claim 2, wherein each engine in the one or more engines, each propeller in the one or more propellers, each air duct in the one or more air ducts, and each safety guard in the one or more safety guards together form a propulsion assembly that is configured to be removably mounted to a body of the unmanned aerial vehicle.

14. The unmanned aerial vehicle according to claim 13, wherein the unmanned aerial vehicle is modular such that the body is configured to receive one or more propulsion assemblies, each propulsion assembly comprising an engine, a propeller, an air duct and a safety guard.

15. The unmanned aerial vehicle according to claim 14, wherein a number of propulsion assemblies mounted to the body depends on a weight of a package to be carried by the unmanned aerial vehicle.

16. The unmanned aerial vehicle according to claim 2, wherein the one or more safety guards are mounted to a wall of the one or more air ducts, each of the one or more safety guards comprising a plurality of plates that are configured to move relative to each other in one plane to open or close each air inlet opening, each air outlet opening, or both.

17. The unmanned aerial vehicle according to claim 16, further comprising one or more actuators configured to actuate the plurality of plates to close or open each air inlet opening, each air outlet opening, or both.

18. The unmanned aerial vehicle according to claim 2, further comprising a body, wherein the one or more engines, the flight control system and the one or more air ducts are mounted to the body.
